(19) United States
(12) Patent Application Publication
(10) Pub. No.: US 2024/0340636 A1
(43) Pub. Date: Oct. 10, 2024

(54) Handling User Equipment Identifications

(71) Applicant: Telefonaktiebolaget LM Ericsson (publ), Stockholm (SE)

(72) Inventors: Maria Luisa Mas Rosique, Tres Cantos (ES); Wenliang Xu, Shanghai (CN); Magnus Olsson, London (GB)

(21) Appl. No.: 18/292,127

(22) PCT Filed: Jul. 29, 2022
(86) PCT No.: PCT/EP2022/071306

§ 371 Date: Jan. 25, 2024

(30) Foreign Application Priority Data
Aug. 6, 2021 (WO) PCT/CN2021/111087

(51) Int. Cl. H04W 8/24

(52) U.S. Cl. CPC H04W 8/24

(57) ABSTRACT

Methods, apparatus and systems performed and configured to operate in a wireless communication network are presented. In example implementations, a method is provided. The method is performed by a first network entity in a core network domain, (CND), of a wireless communication network. The method comprises receiving, by the first network entity from a second entity, a request to retrieve user equipment, (UE), identification. The method further comprises, in response to the request, sending, by the first network entity to a third network entity in the CND, a request to retrieve from the third network entity the UE identification which is specific to the second entity. The first network entity receives from the third network entity the UE identification specific to the second entity. The method further comprises sending, by the first network entity to the second entity, the UE identification specific to the second entity.

### TECHNICAL FIELD

The present disclosure generally relates to wireless communication. In more detail, aspects of the present disclosure relate to the dynamic provisioning of, in particular, application function specific external user and user group identifiers for exposure services. These aspects can be implemented as methods, computer program products, apparatus and systems, and may in particular be implemented in 4^{th} generation (4G) and 5^{th} generation (5G) networks.

### BACKGROUND

The 3^{rd} Generation Partnership Project (3GPP) is developing technical specifications (TSs) for 5G communication systems. 3GPP TS 23.501 V17.1.1 (2021-06) defines architectural aspects of a 5G Service Based Architecture (SBA); procedures have been described in TS 23.502 V17.1.0 (2021-06). According to this SBA, network functions (NFs) use service-based interactions to consume services from other NFs.

The discovery of services and of NFs producing them is provided by a Network Repository Function (NRF).

The 5G Architecture with service-based interfaces can be seen in FIG. 1.

FIG. 1 illustrates a block diagram of a wireless communication network 100 according to examples described herein. In this example, the 5G network architecture may relate to a non-roaming architecture.

Having service-based interfaces in the 5G Core Control Plane (CP) implies that the NFs in the 5G Core CP provide services that are consumed by other NFs in the 5G Core CP.

A portion of the 5G reference architecture is defined by 3GPP. Some architectural core network entities (network functions, NFs) and core network interfaces for examples of the present disclosure may include:
1) A User Equipment (UE) 102 as an exemplary terminal device. The UE 102 constitutes, for example, an endpoint of a voice-over-IP call or of a video or audio streaming session that stretches via the access network domain (AND), such as via a (radio) access network ((R)AN) 104.
2) An Application Function (AF) 126 located outside the core network domain (CND) and typically implemented as, or on, an application server operated by a dedicated service provisioning entity (e.g., an Over-the-top (OTT) entity). The AF 126 is configured to interact with the CND via an Naf interface.
   Generally, the AF interacts with the 3GPP Core Network in order to provide or consume services. The functionality and purpose of AFs are only defined in the specification with respect to their interaction with the 3GPP Core Network, but as an example, the AF can be part of an Application Server or interact with the Core Network on behalf of the Application Server(s).
3) A Network Exposure Function (NEF) 118 has an Nnef interface and supports different functionalities. Specifically, in the context of some examples outlined herein, the NEF 118 may act as an entry point into the CND for the AF 126. The AF 126 thus interacts with the CND through the NEF 118. The NEF is the entry point for application Service Providers (ASPs) to the Mobile Network Operator (MNO), also known as Connectivity Service Provider (CSP). NEF exposes the Mobile Network capabilities and events to the ASPs as services over a service based interface (SBI). Among other, NEF complements the information provided by the external Application Functions (AFs), authorizes AF requests and translates internal-external information. The AF may be deployed either by an operator or a third party.
4) A Session Management Function (SMF) 114 has N4 and Nsmf interfaces. The SMF 114 supports procedures such as session establishment, modification and release as well as policy-related functionalities. In particular, the SMF 114 configures User Plane Function (UPF) 106 (for example for event reporting). Generally, the SMF is responsible, inter alia, for selection and control of UPF entities. Moreover, in some examples, the SMF 114 configures the UPF 106 accordingly through the N4 interface using Packet Forwarding Control Protocol (PFCP) procedures.
5) The Binding Support Function (BSF) is used to find the Policy Control Function (PCF) in charge of the user Protocol Data Unit (PDU) Session policy session in scenarios with more than one PCF.
6) The User Plane Function (UPF) 106 has an N4 interface to the SMF 114 and an N3 interface to (R)AN 104. The UPF 106 supports handling of user plane traffic on the user plane (UP) based on the rules received from the SMF 114 in the control plane (CP). In particular, in examples outlined herein, the UPF 106 thus supports packet inspection and different enforcement actions (such as, for example, event detection and reporting).
7) The Policy Control Function (PCF) 122 supports, via an Npcf interface, a unified policy framework to govern the (core) network (domain) behavior. Specifically, the PCF 122 provides Policy and Charging Control (PCC) rules to SMF 114 and/or UPF 106 to, e.g., detect service traffic and enforce policy and charging decisions according to the PCC rules. The PCF is an optional entity in the 5G core.
8) A unified data management (UDM) entity 124 centrally stores data (e.g., subscriber information) in the core network domain. The UDM performs subscription management and User Identification Handling among other. To provide this functionality, the UDM uses subscription data (including authentication data) that may be stored in a User Data Repository, in which case a UDM implements the application logic and does not require an internal user data storage.
9) An access and mobility management function (AMF) 112 handles access and mobility for the UE 102.
10) A Network Repository Function (NRF) 120 is provided in the wireless communication network 100. The NRF supports in particular the following functionality:
   The NRF supports the service discovery function. The NRF may receive an NF Discovery Request from an NF instance, and may provide the information of the discovered NF instances.
   Furthermore, the NRF may maintain the NF profile of available NF instances and their supported services.
11) The Network Slice Selection Function (NSSF) 116 may support selecting the set of network slice instances serving the UE 102. Furthermore, the NSSF 116 may determine an AMF 112 Set to be used to serve the UE 102, or, based on configuration, a list of candidate AMF(s), possibly by querying the NRF 120.
12) The Authentication Server Function (AUSF) 110 supports authentication for 3GPP access and untrusted non-3GPP access as specified in TS 33.501. It may further support network slice-specific authentication and authorization as specified in TS 23.502.
13) The Data Network (DN) 108, is coupled to the UPF 106 via interface N6. The DN 108 may, for example, relate to operator services, Internet access or third party services.

PCF and BSF are conditional 5GC NFs, which may or may not be deployed conditioned to the services supported by the network. As an example, Voice over Longterm Evolution (VoLTE) requires that PCF and BSF are deployed.

When at User PDU Session establishment, the SMF that manages the User PDU Session establishes a policy association with a PCF, the PCF registers the PDU Session in BSF. For that, it uses service operation Nbsf_Management_Register, which requires the UE address, which can be then IP address/prefix or MAC address as defined in TS 23.501 V17.1.1 (2021-06). Subscription Permanent Identifier (SUPI) may also be included (for more information see TS 23.502 referred to above).

Further functionalities and couplings between the entities comprised in the wireless communication network 100 can be found, e.g., in 3GPP TS 23.501 V17.1.1 (2021-06).

### Application Service Provider (ASP)- Connectivity Service Provider (CSP) Collaborative Solutions

3GPP has specified the services to expose different network capabilities to applications. AF is the NF that interacts with the 3GPP Core Network to consume these services. AFs are not allowed by the operator to access directly the NFs that provide the services. AFs shall use the external exposure framework (see clause 7.3 in 3GPP TS 23.501 V17.1.1 (2021-06)) and interact with relevant NFs via NEF.

A complete list of the services where AF and NEF interact can be found in 3GPP TS 23.501 V17.1.1 (2021-06) and TS 23.502 V17.1.0 (2021-06).

The AF requests to NEF a specific User PDU Session service flow or application, a user or a group of users. Or it may not be related to one or more specific users but applicable to certain DN, slice or to all CSP users. The service specification specifies the input parameters of each service operations (see TS 23.502 V17.1.0 (2021-06)). The identifiers that may be used to specify the target of the request may vary among service operation. Examples of identifiers used are the user internet protocol (IP) or media access control (MAC) address (e.g. when that refers to certain PDU Session), Generic Public Subscription Identifier (GPSI) (e.g. to refer to a subscriber), or an External Group Identifier (to refer to a group of subscribers).

An assumption is that the AF has visibility of the user service connection and so of the IP/MAC addresses and it can include them as identifiers when the request relates to an ongoing PDU Session.

### 5G System (5GS) Identifiers

TS 23.502 V17.1.0 (2021-06) and TS 23.003 V17.2.0 (2021-06) specify several identifiers that are used in 5GS, among them the following.
SUPI is a globally unique 5G Subscription Permanent Identifier (SUPI) that shall be allocated to each subscriber in the 5G System and provisioned in the UDM/UDR. The SUPI is used only inside the 3GPP system.
GPSI is needed for addressing a 3GPP subscription in different data networks outside of the 3GPP system. The 3GPP system stores within the subscription data the association between the GPSI and the corresponding SUPI. GPSIs are public identifiers used both inside and outside of the 3GPP system. The GPSI is either a Mobile Station Integrated Services Digital Network Number (MSISDN) or an External Identifier, see TS 23.003 V17.2.0 (2021-06).
An External Identifier identifies a subscription associated to an International Mobile Subscriber Identity (IMSI). A subscription associated to an IMSI may have one or several External Identifier(s). It is globally unique.
An Internal-Group Identifier is a network internal globally unique identity which identifies a set of SUPIs (e.g. Machine Type Communication (MTC) devices) from a given network. The subscription data for a UE in UDR may associate the subscriber with groups. Where a UE can belong to a limited number of groups, the exact number is defined in stage 3 specifications.
An External Group Identifier identifies a group made up of one or more subscriptions associated to a group of IMSIs. It is globally unique.

### Network Address Translation

Network address translation (NAT) is a method of remapping one IP address space into another by modifying network address information in the IP header of packets while they are in transit across a traffic routing device. It has become a popular and essential tool in conserving global address space in the face of IPv4 address exhaustion.

The vast majority of Internet traffic uses Transmission Control Protocol (TCP) or User Datagram Protocol (UDP). For these protocols, the port numbers are changed so that the combination of IP address and port information on the returned packet can be unambiguously mapped to the corresponding mobile core network destination. RFC 2663 uses the term network address and port translation (NAPT) for this type of NAT. This is the most common type of NAT and has become synonymous with the term “NAT” in common usage.

NAT is deployed on the N6 interface, and so that packets passing from the 5G core (5GC) to the DN will have their source address and port modified, while packets passing from the DN back will have their destination address and port modified. In that scenario, the source IP address that the Application server extracts from the user data packets are not the same as the source IP address known to the Mobile Core, which affects the AF interaction with the 5GC.

This problem is recognized in 3GPP specifications and has been addressed as outlined, for example, in US 2014/0325091 A1. In these solutions, information of IP address and port translation performed by NAT function is shared to the policy controller (PCF or Policy and Charging Rules Function (PCRF)) and BSF upon request directly via some other node. The relation of address/port after NAT to address/port before NAT can be used to resolve the first one into the second one when it is included in a service request by the AF.

State of the art NATs support mechanisms like Internet Protocol Flow Information Export (IPFIX) to export data. IP Flow Information Export aka IPFIX is an extended version of NetFlow v9, standardized by the Internet Engineering Task Force (IETF). It supports variable length fields like Hypertext Transfer Protocol (HTTP) hostname or HTTP Uniform Resource Locator (URL) as well as enterprise-defined fields. IPFIX allows to collect and analyze flow data from layer 3 devices and firewalls with an IPFIX collector and IPFIX analyzer.

When an AF consumes a service that requires identifying a specific subscriber or a group of subscribers in its interaction with NEF, it needs to be provisioned with identifiers that can be used externally, those are GPSI and External Group Identifier.

Some solutions have been discussed in 3GPP as part of SA Working Group (WG) 2 meeting #143e for how to define a service for AF to obtain from the user IP address an identifier for the subscription: it was proposed to update existing NEF APIs, and a BSF centric solution was proposed. At that point there was no decision, but a question on the topic was sent to SA WG3 (Security). SA WG3 states that using MSISDN as GPSI raises security concerns and it is not a valid option.

### SUMMARY

Accordingly, there is a need to address the above.

According to a first aspect, a method performed by a first network entity in a core network domain, CND, of a wireless communication network is provided. The method comprises receiving, by the first network entity from a second entity, a request to retrieve user equipment, UE, identification. In response to the request, the first network entity sends, to a third network entity in the CND, a request to retrieve from the third network entity the UE identification which is specific to the second entity. The first network entity receives, from the third network entity, the UE identification specific to the second entity. The first network entity sends, to the second entity, the UE identification specific to the second entity.

In a second aspect of the present disclosure, a method in a wireless communication network comprising a first network entity in a CND of the wireless communication network and a second entity is provided. The method is performed by the second entity. The method comprises sending, by the second entity to the first network entity, a request to retrieve user equipment, UE, identification which is specific to the second entity. The second entity receives, from the first network entity, the UE identification specific to the second entity.

In a third aspect of the present disclosure, a method performed by a network entity in a core network domain, CND, of a wireless communication network is provided. The method comprises generating, using an application service provider identifier, a modified version of one or both of external user equipment, UE, identification and an external group identifier, wherein the external UE identification identifies a subscription for the UE and wherein the external group identifier refers to one or more subscriptions. The method further comprises generating a token for the modified version of one or both of the external UE identification and the external group identifier.

Also provided is a computer program product comprising program code portions that, when executed on at least one processor, configure the processor to perform the method of any of the preceding aspects. The computer program product may be stored on a computer-readable recording medium or may be encoded in a data signal.

Furthermore, an apparatus adapted to operate in a CND of a wireless communication network is provided. The apparatus is configured to receive, from a second entity, a request to retrieve user equipment, UE, identification. In response to the request, the apparatus is configured to send, to a third network entity in the CND, a request to retrieve from the third network entity the UE identification which is specific to the second entity. The apparatus is further configured to receive, from the third network entity, the UE identification specific to the second entity. The apparatus is further configured to send, to the second entity, the UE identification specific to the second entity.

The apparatus discussed above may be configured to perform the method of the first method aspect and any (preferred) example implementations outlined throughout the present disclosure thereof.

A further apparatus adapted to operate in a wireless communication network is provided. The apparatus is configured to send, to a first network entity in a CND of the wireless communication network, a request to retrieve user equipment, UE, identification which is specific to the apparatus. The apparatus is further configured to receive, from the first network entity, the UE identification specific to the apparatus. The apparatus may be configured to perform the method of the second method aspect and any (preferred) example implementations outlined throughout the present disclosure thereof.

A further apparatus adapted to operate in a wireless communication network is provided. The apparatus is configured to generate, using an application service provider identifier, a modified version of one or both of external user equipment, UE, identification and an external group identifier. The external UE identification identifies a subscription for the UE and the external group identifier refers to one or more subscriptions. The apparatus is further configured to generate a token for the modified version of one or both of the external UE identification and the external group identifier. The apparatus may be configured to perform the method of the third method aspect and any (preferred) example implementations outlined throughout the present disclosure thereof.

A system as presented herein comprises any two or more apparatuses discussed above.

### BRIEF DESCRIPTION OF THE DRAWINGS

Further aspects, details and advantages of the present disclosure will become apparent from the detailed description of exemplary embodiments below and from the drawings, wherein:

FIG. 1 is a diagram illustrating an exemplary 5G network architecture that may form the basis of examples of the present disclosure;

FIG. 2 is a flow diagram illustrating an AF specific UE identification (ID) retrieval procedure according to examples of the present disclosure;

FIGS. 3 to 5 illustrate flow diagrams of methods according to examples of the present disclosure; and

FIG. 6 is a block diagram of a system according to examples of the present disclosure.

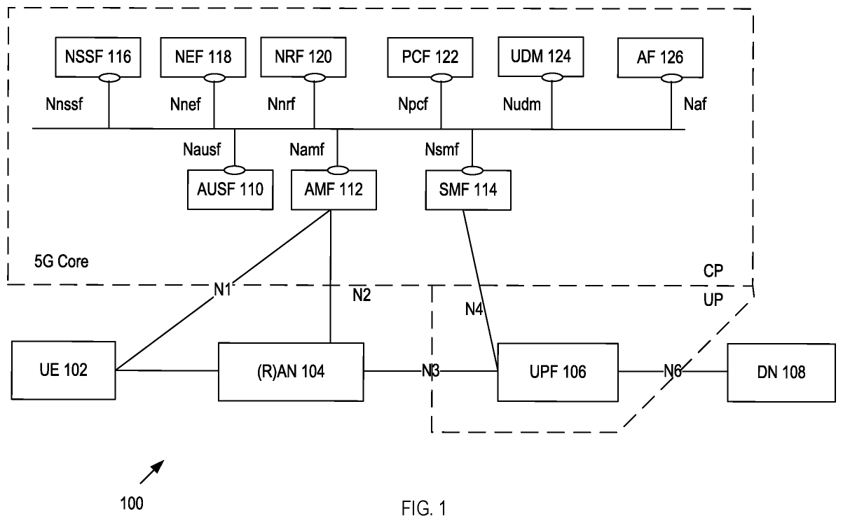

### DETAILED DESCRIPTION

In the following description, for purposes of explanation and not limitation, specific details are set forth in order to provide a thorough understanding of the present disclosure. It will be apparent to one of skill in the art that the present disclosure may be practiced in other embodiments that depart from these specific details.

While, for example, the following description focuses on an exemplary network configuration in accordance with 5G specifications, the present disclosure is not limited in this regard throughout. The present disclosure could, for example, also be implemented in other cellular or non-cellular wireless communication networks, such as those complying with 4^{th} generation (4G) specifications (e.g., in accordance with the Long Term Evolution (LTE) specifications as standardized by the 3^{rd} Generation Partnership Project (3GPP)).

Those skilled in the art will further appreciate that the steps, services and functions explained herein may be implemented using individual hardware circuits, using software functioning in conjunction with a programmed microprocessor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by the one or more processors.

In the following description of exemplary implementations, the same reference numerals denote the same or similar components.

A detailed description of the solution for Dynamic Provisioning of AF Specific External User and User Group Identifiers for Exposure services follows. The solution allows to provision AF with specific UE ID represented by the External Identifier as defined in TS 23.003 V17.2.0 (2021-06), and if requested, with External Group Identifier for the UE as defined in TS 23.003 V17.2.0 (2021-06), which can also be AF specific.

It is to be noted that after retrieving AF specific UE ID or External group Identifier, the AF can invoke NEF provided services (e.g. location monitoring).

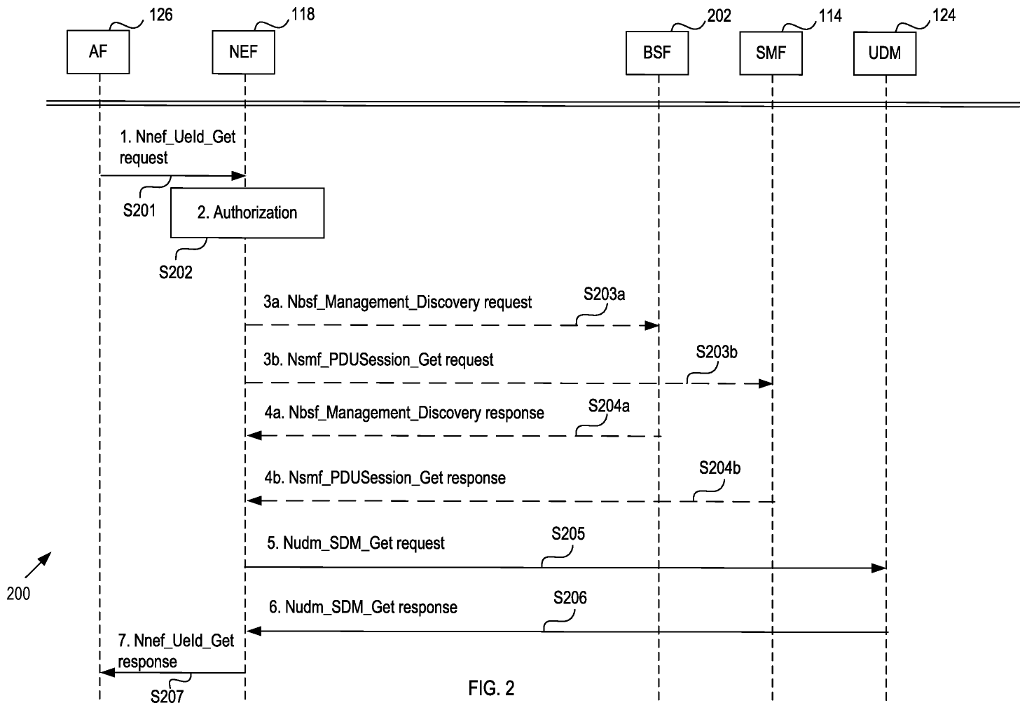

FIG. 2 shows a flow diagram of a method 200 for retrieving AF specific UE ID.

At step S201 (step 1), the AF 126 requests to retrieve UE ID via the Nnef_UeId_Get service operation. The request message may include the UE address, which may be the UE IP address and/or MAC address. The request may include an AF Identifier, which may be an AF Service Identifier and/or include MTC Provider Information. The request includes, in this example, Application Port ID (client and server) and the IP domain.

It is to be noted that the MTC Provider Information can be used by any type of Service Providers (MTC or non-MTC) or Corporate or External Parties for, e.g., distinguishing their different customers.

In this example, the NEF 118 receives NAT information, e.g. it has integrated an IPFIX collector and gets NAT exported data that it uses to translate the UE IP address and application port (client side) after NAT (input parameters in the AF request) into a UE IP address before NAT. The NEF uses the translated address in the requests to the 5GC NFs.

The AF request may include an indicator to request External group identifiers for the UE.

At step S202 (step 2), the NEF 118 authorizes the AF request. If the authorization is not granted, the NEF 118 replies to the AF 126 with a result value indicating authorization failure. Otherwise, the NEF 118 proceeds with the following steps.

The NEF 118 adds the AF-Service ID or MTC provider ID, if missing.

Steps S203a (step 3a) and step 204a (step 4a) relate to an example in which PCF 122/BSF 202 are deployed. In this case, the NEF 118 uses UE address and IP domain in the Nbsf_Management_Discovery service operation to retrieve the session binding information of the UE. If no SUPI is received in the session binding information from the BSF, the NEF 118 replies to the AF 126 with a result value indicating that the UE ID is not available.

Steps S203b (step 3b) and step 204b (step 4b) relate to an example in which PCF122/BSF 202 are not deployed. In this case, the NEF 118 identifies the SMF 114 that owns the IP address based on configuration and uses a new service operation named e.g. Nsmf_PDUSession_Get to retrieve from the SMF 114 the SUPI of the subscriber Nsmf_PDUSession_Get Input parameters include, in this example, the UE address (IP address and/or MAC address), the IP domain, DNN and S-NSSAI, and output parameters include the SUPI.

At step S205 (step 5), the NEF 118 interacts with the UDM 124 to retrieve the AF specific UE ID via the Nudm_SDM_Get service operation. The request message includes SUPI.

The request to the UDM 124 includes, in this example, at least one of Application Port ID, MTC Provider Information and AF Service Identifier as input parameter.

The request to the UDM 124 may include UE group ID indication to indicate that an AF specific UE group ID is also requested as input parameter.

It is to be noted that the NEF 118 may validate the provided MTC Provider Information and override it to an NEF selected MTC Provider Information based on configuration. How the NEF 118 determines the MTC Provider Information, if not present, may, in some examples, be left to implementation (e.g., based on the requesting AF).

At step S206 (step 6), the UDM 124 responds to the NEF 118 with External Identifier and External Group Identifiers (if requested) for the UE which are associated with the Application Port ID and/or MTC provider Information and/or AF Service Identifier.

Table 1 and table 2 shown below describe possible implementation of the extensions to provide the data requested in the Nudm_SDM_Get service operation:
the Identifier Translation Subscription Data Type field may be extended to include as optional External Group Identifier (table 1).
MTC Provider Information and/or AF Service Identifier are added as Data sub keys for Identifier translation (table 2).

Table 1 (possible implementation of additions for Subscription data types (adapted from TS 23.502 V17.1.0 table 5.2.3.3.1-1) part of the Nudm_SubscriberDataManagement Service):

| Subscription data | | |
|---|---|---|
| type | Field | Description |
| Access and Mobility | GPSI List | List of the GPSI (Generic Public Subscription |
| Subscription data | | Identifier) used both inside and outside of the |
| (data needed for UE | | 3GPP system to address a 3GPP subscription |
| Registration and | | (see NOTE 9). |
| Mobility | Internal Group ID-list | List of the subscribed internal group(s) that the |
| Management) | | UE belongs to. |
| | Subscribed UE-AMBR | The maximum aggregated uplink and downlink |
| | | MBRs to be shared across all Non-GBR QoS |
| | | Flows according to the subscription of the user. |
| | Subscribed UE-Slice-MBR(s) | List of maximum aggregated uplink and downlink |
| | | MBRs to be shared across all GBR and Non-GBR |
| | | QoS Flows related to the same S-NSSAI |
| | | according to the subscription of the user. There is |
| | | a single uplink and a single downlink value per S- |
| | | NSSAI. |
| | Subscribed S-NSSAIs | The Network Slices that the UE subscribes to. In |
| | | the roaming case, it indicates the subscribed |
| | | Network Slices applicable to the Serving PLMN |
| | | (NOTE 11). |
| | Default S-NSSAIs | The Subscribed S-NSSAIs marked as default S- |
| | | NSSAI. In the roaming case, only those applicable |
| | | to the Serving PLMN (NOTE 12). |
| | S-NSSAIs subject to Network | The Subscribed S-NSSAIs marked as subject to |
| | Slice-Specific Authentication | NSSAA. When present, the GPSI list shall include |
| | and Authorization | at least one GPSI. |
| | Network Slice Simultaneous | Optionally, for each S-NSSAI in the Subscribed S- |
| | Registration Group Information | NSSAIs, one or more value of Network Slice |
| | | Simultaneous Registration Group(s) (NOTE 11) |
| | | associated with the S-NSSAI. |
| | UE Usage Type | As defined in clause 5.15.7.2 of TS 23.501 [2]. |
| | RAT restriction | 3GPP Radio Access Technology(ies) not allowed |
| | | the UE to access. |
| | Forbidden area | Defines areas in which the UE is not permitted to |
| | | initiate any communication with the network. |
| | Service Area Restriction | Indicates Allowed Areas in which the UE is |
| | | permitted to initiate communication with the |
| | | network, and Non-allowed areas in which the UE |
| | | and the network are not allowed to initiate Service |
| | | Request or SM signalling to obtain user services. |
| | Core Network type restriction | Defines whether UE is allowed to connect to 5GC |
| | | and/or EPC for this PLMN. |
| | CAG information | The CAG information includes Allowed CAG list |
| | | and, optionally an indication whether the UE is |
| | | only allowed to access 5GS via CAG cells as |
| | | defined in clause 5.30.3 of TS 23.501 [2]. |
| | CAG information Subscription | When present, indicates to the serving AMF that |
| | Change Indication | the CAG information in the subscription data |
| | | changed and the UE must be updated. |
| | RFSP Index | An index to specific RRM configuration in the NG- |
| | | RAN. |
| | Subscribed Periodic | Indicates a subscribed Periodic Registration |
| | Registration Timer | Timer value, which may be influenced by e.g. |
| | | network configuration parameter as specified in |
| | | clause 4.15.6.3a. |
| | Subscribed Active Time | Indicates a subscribed active time value, which |
| | | may be influenced by e.g. network configuration |
| | | parameter as specified in clause 4.15.6.3 a. |
| | MPS priority | Indicates the user is subscribed to MPS as |
| | | indicated in clause 5.16.5 of TS 23.501 [2]. |
| | MCX priority | Indicates the user is subscribed to MCX as |
| | | indicated in clause 5.16.6 of TS 23.501 [2]. |
| | AMF-Associated Expected UE | Information on expected UE movement and |
| | Behaviour parameters | communication characteristics. See |
| | | clause 4.15.6.3 |
| | Steering of Roaming | List of preferred PLMN/access technology |
| | | combinations or HPLMN indication that no change |
| | | of the “Operator Controlled PLMN Selector with |
| | | Access Technology” list stored in the UE is |
| | | needed (see NOTE 3). |
| | | Optionally includes an indication that the UDM |
| | | requests an acknowledgement of the reception of |
| | | this information from the UE. |
| | SoR Update Indicator for Initial | An indication whether the UDM requests the AMF |
| | Registration | to retrieve SoR information when the UE performs |
| | | Registration with NAS Registration Type “Initial |
| | | Registration”. |
| | SoR Update Indicator for | An indication whether the UDM requests the AMF |
| | Emergency Registration | to retrieve SoR information when the UE performs |
| | | Registration with NAS Registration Type |
| | | “Emergency Registration”. |
| | Network Slicing Subscription | When present, indicates to the serving AMF that |
| | Change Indicator | the subscription data for network slicing changed |
| | | and the UE configuration must be updated. |
| | Tracing Requirements | Trace requirements about a UE (e.g, trace |
| | | reference, address of the Trace Collection Entity, |
| | | etc.) is defined in TS 32.421 [39]. |
| | | This information is only sent to AMF in the |
| | | HPLMN or one of its equivalent PLMN(s). |
| | Inclusion of NSSAI in RRC | When present, it is used to indicate that the UE is |
| | Connection Establishment | allowed to include NSSAI in the RRC connection |
| | Allowed | Establishment in clear text for 3GPP access. |
| | Service Gap Time | Used to set the Service Gap timer for Service Gap |
| | | Control (see clause 5.31.16 of TS 23.501 [2]). |
| | Subscribed DNN list | List of the subscribed DNNs for the UE (NOTE 1). |
| | | Used to determine the list of LADN available to |
| | | the UE as defined in clause 5.6.5 of |
| | | TS 23.501 [2]. |
| | UDM Update Data | Includes a set of parameters (e.g. updated Default |
| | | Configured NSSAI and/or updated Routing |
| | | Indicator) to be delivered from UDM to the UE via |
| | | NAS signalling as defined in clause 4.20 |
| | | (NOTE 3). |
| | | Optionally includes an indication that the UDM |
| | | requests an acknowledgement of the reception of |
| | | this information from the UE and an indication for |
| | | the UE to re-register. |
| | NB-IoT UE priority | Numerical value used by the NG-RAN to prioritise |
| | | between UEs accessing via NB-IoT. |
| | Enhanced Coverage Restriction | Specifies whether CE mode B is restricted for the |
| | | UE, or both CE mode A and CE mode B are |
| | | restricted for the UE, or both CE mode A and CE |
| | | mode B are not restricted for the UE. |
| | NB-IoT Enhanced Coverage | Indicates whether Enhanced Coverage for NB-IoT |
| | Restriction | UEs is restricted or not. |
| | IAB-Operation allowed | Indicates that the subscriber is allowed for IAB- |
| | | operation as specified in clause 5.35.2 of |
| | | TS 23.501 [2]. |
| | Charging Characteristics | It contains the Charging Characteristics as |
| | | defined in Annex A of TS 32.256 [71]. |
| | | This information, when provided, shall override |
| | | any corresponding predefined information at the |
| | | AMF. |
| | Extended idle mode DRX cycle | Indicates a subscribed extended idle mode DRX |
| | length | cycle length value. |
| | PCF Selection Assistance info | list of combination of DNN and S-NSSAI that |
| | | indicates that the same PCF needs to be selected |
| | | for AM Policy Control and SM Policy Control |
| | | (NOTE 10). |
| Slice Selection | Subscribed S-NSSAIs | The Network Slices that the UE subscribes to. In |
| Subscription data | | roaming case, it indicates the subscribed network |
| (data needed for | | slices applicable to the serving PLMN (NOTE 11). |
| Slice Selection as | Default S-NSSAIs | The Subscribed S-NSSAIs marked as default S- |
| described in | | NSSAI. In the roaming case, only those applicable |
| clause 4.2.2.2.3 and | | to the Serving PLMN (NOTE 12). |
| in clause 4.11.0a.5) | S-NSSAIs subject to Network | The Subscribed S-NSSAIs marked as subject to |
| | Slice-Specific Authentication | NSSAA. |
| | and Authorization | |
| | Network Slice Simultaneous | Optionally, for each S-NSSAI in the Subscribed S- |
| | Registration Group (SRG) | NSSAIs, the one or more value of Network Slice |
| | Information | Simultaneous Registration Group(s) (NOTE 11) |
| | | associated with the S-NSSAI. |
| SMF Selection | SUPI | Key |
| Subscription data | SMF Selection Subscription data contains one or more S-NSSAI level | |
| (data needed for SMF | subscription data: | |
| Selection as | S-NSSAI | Indicates the value of the S-NSSAI. |
| described | Subscribed DNN list | List of the subscribed DNNs for the UE (NOTE 1). |
| in clause 6.3.2 of | Default DNN | The default DNN if the UE does not provide a |
| TS 23.501 [2]) | | DNN (NOTE 2). |
| | LBO Roaming Information | Indicates whether LBO roaming is allowed per |
| | | DNN, or per (S-NSSAI, subscribed DNN). |
| | Interworking with EPS indication | Indicates whether EPS interworking is supported |
| | list | per (S-NSSAI, subscribed DNN). |
| | Same SMF for Multiple PDU | Indication whether the same SMF for multiple |
| | Sessions to the same DNN and | PDU Sessions to the same DNN and S-NSSAI is |
| | S-NSSAI | required. |
| | Invoke NEF indication | When present, indicates, per S-NSSAI and per |
| | | DNN, that NEF based infrequent small data |
| | | transfer shall be used for the PDU Session (see |
| | | NOTE 8). |
| | SMF information for static IP | When static IP address/prefix is used, this may be |
| | address/prefix | used to indicate the associated SMF information |
| | | per (S-NSSAI, DNN). |
| UE context in SMF | SUPI | Key. |
| data | PDU Session Id(s) | List of PDU Session Id(s) for the UE. |
| | For emergency PDU Session Id: | |
| | Emergency Information | The SMF + PGW-C FQDN for emergency session |
| | | used for interworking with EPC. |
| | For each non-emergency PDU Session Id: | |
| | DNN | DNN for the PDU Session. |
| | SMF | Allocated SMF for the PDU Session. Includes |
| | | SMF IP Address and SMF NF Id. |
| | SMF + PGW-C FQDN | The S5/S8 SMF + PGW-C FQDN used for |
| | | interworking with EPS (see NOTE 5). |
| | PCF ID | The PCF ID serving the PDU Session/PDN |
| | | Connection. |
| SMS Management | SMS parameters | Indicates SMS parameters subscribed for SMS |
| Subscription data | | service such as SMS teleservice, SMS barring list |
| (data needed by | Trace Requirements | Trace requirements about a UE (e.g. trace |
| SMSF for SMSF | | reference, address of the Trace Collection Entity, |
| Registration) | | etc.) is defined in TS 32.421 [39]. |
| | | This information is only sent to a SMSF in |
| | | HPLMN. |
| SMS Subscription | SMS Subscription | Indicates subscription to any SMS delivery service |
| data | | over NAS irrespective of access type. |
| (data needed in AMF) | | |
| UE Context in SMSF | SMSF Information | Indicates SMSF allocated for the UE, including |
| data | | SMSF address and SMSF NF ID. |
| | Access Type | 3GPP or non-3GPP access through this SMSF |
| Session Management | GPSI List | List of the GPSI (Generic Public Subscription |
| Subscription data | | Identifier) used both inside and outside of the |
| (data needed for PDU | | 3GPP system to address a 3GPP subscription. |
| Session | Internal Group ID-list | List of the subscribed infernal group(s) that the |
| Establishment) | | UE belongs to. |
| | Trace Requirements | Trace requirements about a UE (e.g. trace |
| | | reference, address of the Trace Collection Entity, |
| | | etc . . .) is defined in TS 32.421 [39]. |
| | | This information is only sent to a SMF in the |
| | | HPLMN or one of its equivalent PLMN(s). |
| | Session Management Subscription data contains one or more S-NSSAI level | |
| | subscription data: | |
| | S-NSSAI | Indicates the value of the S-NSSAI. |
| | Subscribed DNN list | List of the subscribed DNNs for the S-NSSAI |
| | | (NOTE 1). |
| | For each DNN in S-NSSAI level subscription data: | |
| | DNN | DNN for the PDU Session. |
| | Framed Route information | Set of Framed Routes. A Framed Route refers to |
| | | a range of IPv4 addresses/IPv6 Prefixes to |
| | | associate with a PDU Session established on this |
| | | (DNN, S-NSSAI). |
| | | See NOTE 4. |
| | IP Index information | Information used for selecting how the UE IP |
| | | address is to be allocated (see clause 5.8.2.2.1 in |
| | | TS 23.501 [2]). |
| | Allowed PDU Session Types | Indicates the allowed PDU Session Types (IPv4, |
| | | IPv6, IPv4v6, Ethernet, and Unstructured) for the |
| | | DNN, S-NSSAI. See NOTE 6. |
| | Default PDU Session Type | Indicates the default PDU Session Type for the |
| | | DNN, S-NSSAI. |
| | Allowed SSC modes | Indicates the allowed SSC modes for the DNN, S- |
| | | NSSAI. |
| | Default SSC mode | Indicate the default SSC mode for the DNN, S- |
| | | NSSAI. |
| | Interworking with EPS indication | Indicates whether interworking with EPS is |
| | | supported for this DNN and S-NSSAI. |
| | 5GS Subscribed QoS profile | The QoS Flow level QoS parameter values (5QI |
| | | and ARP) for the DNN, S-NSSAI (see |
| | | clause 5.7.2.7 of TS 23.501 [2]). |
| | Charging Characteristics | It contains Charging Characteristics as defined in |
| | | Annex A clause A.1 of TS 32.255 [45]. This |
| | | information, when provided, shall override any |
| | | corresponding predefined information at the SMF. |
| | Subscribed-Session-AMBR | The maximum aggregated uplink and downlink |
| | | MBRs to be shared across all Non-GBR QoS |
| | | Flows in each PDU Session, which are |
| | | established for the DNN, S-NSSAI. |
| | Static IP address/prefix | Indicate the static IP address/prefix for the DNN, |
| | | S-NSSAI. |
| | User Plane Security Policy | Indicates the security policy for integrity protection |
| | | and encryption for the user plane. |
| | PDU Session continuity at inter | Provides for this DDN, S-NSSAI how to handle a |
| | RAT mobility | PDU Session when UE the moves to or from NB- |
| | | IoT. Possible values are: maintain the PDU |
| | | session; disconnect the PDU session with a |
| | | reactivation request; disconnect PDU session |
| | | without reactivation request; or to leave it to local |
| | | VPLMN policy. |
| | NEF Identity for NIDD | When present, indicates, per S-NSSAI and per |
| | | DNN, the identity of the NEF to anchor |
| | | Unstructured PDU Session. When not present for |
| | | the S-NSSAI and DNN, the PDU session |
| | | terminates in UPF (see NOTE 8). |
| | NIDD information | Information such as External Group Identifier, |
| | | External Identifier, MSISDN, or AF ID used for |
| | | SMF-NEF Connection. |
| | SMF-Associated Expected UE | Parameters on expected characteristics of a PDU |
| | Behaviour parameters | Session their corresponding validity times as |
| | | specified in clause 4.15.6.3. |
| | Suggested number of downlink | Parameters on expected PDU session |
| | packets | characteristics as specified in clauses 4.15.3.2.3b |
| | | and 4.15.6.3a. |
| | ATSSS information | Indicates whether MA PDU session establishment |
| | | is allowed. |
| | Secondary authentication | Indicates that whether the Secondary |
| | indication | authentication/authorization (as defined in |
| | | clause 5.6 of TS 23.501 [2]) is required for |
| | | PDU Session Establishment as specified in |
| | | clause 4.3.2.3. |
| | DN-AAA server UE IP address | Indicates that whether the SMF is required to |
| | allocation indication | request the UE IP address from the DN-AAA |
| | | server (as defined in clause 5.6 of TS 23.501 [2]) |
| | | for PDU Session Establishment as specified in |
| | | clause 4.3.2.3. |
| | DN-AAA server addressing | If at least one of secondary DN-AAA |
| | information | authentication, DN-AAA authorization or DN-AAA |
| | | UE IP address allocation is required by |
| | | subscription data, the subscription data may also |
| | | contain DN-AAA server addressing information. |
| | Edge Configuration Server | Consists of one or more FQDN(s) and/or IP |
| | Address Configuration | Address(es) of Edge Configuration Server(s) as |
| | Information | defined in clause 6.5.2 of TS 23.548 [74]. |
| Identifier translation | SUPI | Corresponding SUPI for input GPSI. |
| | (Optional) MSISDN | Corresponding GPSI (MSISDN) for input GPSI |
| | | (External Identifier). This is optionally provided for |
| | | legacy SMS infrastructure not supporting |
| | | MSISDN-less SMS. The presence of an MSISDN |
| | | should be interpreted as an indication to the NEF |
| | | that MSISDN shall be used to identify the UE |
| | | when sending the SMS to the SMS-SC via T4. |
| | GPSI | Corresponding GPSI for input SUPI and |
| | | associated application information (e.g. |
| | | Application Port ID). (NOTE XX) |
| | (Optional) External Group | Corresponding External Group Identifier for |
| | Identifier | input SUPI and associated application |
| | | information (e.g. Application Port ID). This is |
| | | optionally provided if requested. |
| Intersystem continuity | (DNN, PGW FQDN) list | For each DNN, indicates the SMF + PGW-C which |
| Context | | support interworking with EPC. |
| LCS privacy | LCS privacy profile data | Provides information for LCS privacy classes and |
| (data needed by | | Location Privacy Indication (LPI) as defined in |
| GMLC) | | clause 5.4.2 in TS 23.273 [51] |
| LCS mobile | LCS Mobile Originated Data | When present, indicates to the serving AMF which |
| origination | | LCS mobile originated services are subscribed as |
| (data needed by | | defined in clause 7.1 in TS 23.273 [51]. |
| AMF) | | |
| UE reachability | UE reachability information | Provides, per PLMN, the list of NF IDs or the list |
| | | of NF sets or the list of NF types authorized to |
| | | request notification for UE's reachability |
| | | (NOTE 7). |
| V2X Subscription | NR V2X Services Authorization | Indicates whether the UE is authorized to use the |
| data (see | | NR sidelink for V2X services as Vehicle UE, |
| TS 23.287 [73]) | | Pedestrian UE, or both. |
| | LTE V2X Services Authorization | Indicates whether the UE is authorized to use the |
| | | LTE sidelink for V2X services as Vehicle UE, |
| | | Pedestrian UE, or both. |
| | NR UE-PC5-AMBR | AMBR of UE's NR sidelink (i.e. PC5) |
| | | communication for V2X services. |
| | LTE UE-PC5-AMBR | AMBR of UE's LTE sidelink (i.e. PC5) |
| | | communication for V2X services. |
| ProSe Subscription | ProSe Service Authorization | Indicates whether the UE is authorized to use |
| data (see | | ProSe Direct Discovery, ProSe Direct |
| TS 23.304 [77]) | | Communication, or both and whether the UE is |
| | | authorized to use or serve as a ProSe UE-to- |
| | | Network Relay. |
| | ProSe NR UE-PC5-AMBR | AMBR of UE's NR sidelink. (i.e. PC5) |
| | | communication for ProSe services. |
| MBS Subscription | MBS Service Authorization | Indicates whether the UE is authorized to use |
| data (see | | Multicast MBS service. |
| TS 23.247 [78]) | | |

(NOTE 1):
The Subscribed DNN list can include a wildcard DNN.
(NOTE 2):
The default DNN shall not be a wildcard DNN.
(NOTE 3):
The Steering of Roaming information and UDM Update Data are protected using the mechanisms defined in TS 33.501 [15].
NOTE 4:
Framed Route information and Framed Route(s) are defined in TS 23.501 [2].
(NOTE 5):
Depending on the scenario PGW-C FQDN may be for S5/S8, or for S2b (ePDG case).
NOTE 6:
The Allowed PDU Session Types configured for a DNN which supports interworking with EPC should contain only the PDU Session Type corresponding to the PDN Type configured in the APN that corresponds to the DNN.
(NOTE 7):
Providing a list of NF types or a list of NF sets may be more appropriate for some deployments, e.g. in highly dynamic NF lifecycle management deployments.
(NOTE 8):
For a S-NSSAI and a DNN, the “Invoke NEF Indication” shall be present in the SMF selection subscription data if and only if the “NEF Identity for NIDD” Session Management Subscription Data includes a NEF Identity. When the “NEF Identity for NIDD” Session Management Subscription Data includes a NEF Identity for a S-NSSAI and DNN, the “Control Plane Only Indicator” will always be set for PDU Sessions to this S-NSSAI and DNN (see clause 5.31.4.1 of TS 23.501 [2]).
(NOTE 9):
When multiple GPSIs are included in the GPSI list, any GPSI in the list can be used in NSSAA procedures.
(NOTE 10):
The same PCF can be selected to serve the UE and to serve one or multiple PDU sessions, each of them is indicated in the list of S-NSSAI, DNN combinations in the PCF Selection Assistance Info. Providing one combination of DNN and S-NSSAI in the PCF Selection Assistance Info is assumed if interworking with EPS is needed. In case multiple PDU sessions to one DNN, S-NSSAI are established in EPS, it is appropriate to select same PCF by configuration or by using existing method, e.g. same PCF selection in usage monitoring.
(NOTE 11):
If Network Slice Simultaneous Registration Group information is present, and the VPLMN does not support the subscription-based restrictions to simultaneous registration of network slices, the subset of the Subscribed S-NSSAIs defined in clause 5.15.12 of TS 23.501 [2], are included, without providing the SRG information.
(NOTE 12):
The Default S-NSSAIs (if more than one is present) are associated with common NSSRG values if NSSRG information is present. At least one Default S-NSSAI shall be present in a subscription including NSSRG information.
NOTE XX:
A GPSI may be associated with Application Port ID, MTC Provider Information and/or AF Service Identifier.

Table 2 (proposed extensions to the Data sub keys for Identifier Translation Subscription Data Type (adapted from TS 23.502 V17.1.0, table 5.2.3.3.1-3) in the Nudm_SubscriberDataManagement Service):

| Subscription Data Types | Data Key | Data Sub Key |
|---|---|---|
| Access and Mobility Subscription data | SUPI | Serving PLMN IDand |
| | | optionally NID |
| SMF Selection Subscription data | SUPI | Serving PLMN ID and |
| | | optionally NID |
| UE context in SMF data | SUPI | S-NSSAI |
| SMS Management Subscription data | SUPI | Serving PLMN ID and |
| | | optionally NID |
| SMS Subscription data | SUPI | Serving PLMN ID and |
| | | optionally NID |
| UE Context in SMSF data | SUPI | — |
| Session Management Subscription data | SUPI | S-NSSAI |
| | | DNN |
| | | Serving PLMN ID and |
| | | optionally NID |
| Identifier translation | GPSI | — |
| | SUPI | Application Port ID, MTC |
| | | Provider Information, |
| | | AF Service Identifier |
| Slice Selection Subscription data | SUPI | Serving PLMN ID and |
| | | optionally NID |
| Intersystem continuity Context | SUPI | DNN |
| LCS privacy | SUPI | — |
| LCS mobile origination | SUPI | — |
| UE reachability | SUPI | — |
| V2X Subscription data | SUPI | — |
| ProSe Subscription data | SUPI | — |
| MBS Subscription data | SUPI | — |

At step S207 (step 7), the NEF 118 further responds to the AF 126 with the information received from the UDM 124.

The solution requires extending UDM Data Management for subscribers and groups to support External UE IDs and External Group identifiers which may be specific to an application, AF-service or MTC provider, depending on the granularity level selected. The granularity of these identifiers needs to be agreed with the application service provider (ASP), e.g. at the time of a new MTC provider onboarding.

Then external UE ID and group identifiers are provisioned in UDM for all subscribers and subscriber groups that may require them, and with the granularity agreed with each ASP:
At onboarding (depending on granularity, when applications, AF-services or MTC providers are onboarded): for all subscribers and groups defined in UDM and whenever a new subscriber or subscriber group id is added in UDM that may require them.
Upon demand for a subscriber and group when associated to a SUPI when an authorized request is received in UDM for an external identity for that SUPI.

They may be generated at that moment and stored for future requests (i.e. they may be dynamically provisioned in UDM).

There may be logic in the UDM or in a support function to generate the external UE ID and group identifiers that need to be provisioned in UDM so that they may be unique within 5GC and not possible to correlate to one SUPI by different applications, AF-services or MTC providers.

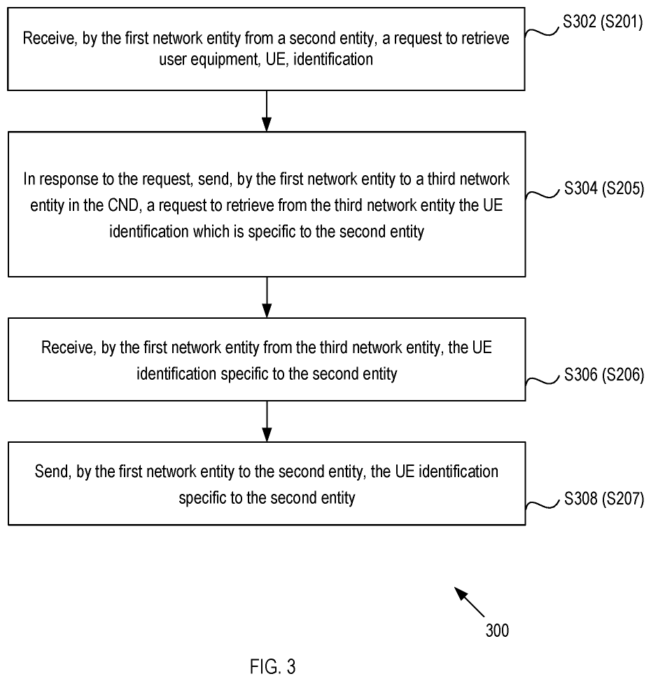

FIG. 3 illustrates a flow diagram of a method 300 according to some examples of the present disclosure.

At step S302 (which may correspond to step S201), the first network entity receives from a second entity, a request to retrieve UE identification.

At step S304 (which may correspond to step S205), the first network entity sends, in response to the request, to a third network entity in the CND, a request to retrieve from the third network entity the UE identification which is specific to the second entity.

At step S306 (which may correspond to step S206), the first network entity receives from the third network entity the UE identification which is specific to the second entity.

At step S308 (which may correspond to step S207), the first network entity sends to the second entity the UE identification specific to the second entity.

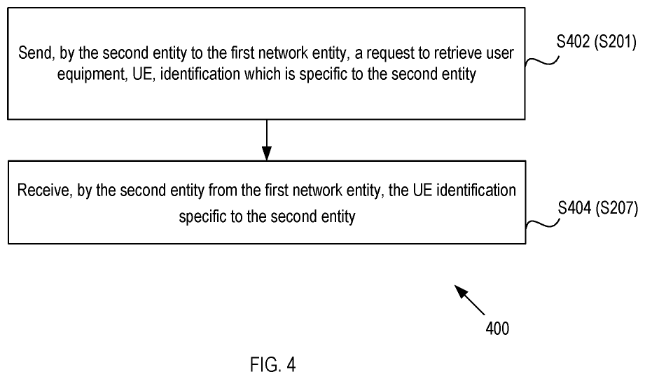

FIG. 4 illustrates a flow diagram of a method 400 according to some examples of the present disclosure.

At step S402 (which may correspond to step S201), the second entity sends to the first network entity a request to retrieve UE identification which is specific to the second entity.

At step S404 (which may correspond to step S207), the second entity receives from the first network entity the UE identification which is specific to the second entity.

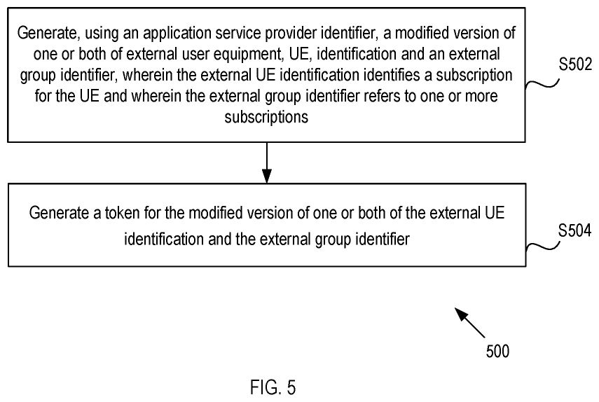

FIG. 5 illustrates a flow diagram of a method 500 according to some examples of the present disclosure. In some examples, the method 500 may be implemented in the method 200 and may be performed by the UDM 124.

At step S502, a network entity generates, using an application service provider identifier, a modified version of one or both of external user equipment, UE, identification and an external group identifier. The external UE identification identifies a subscription for the UE and the external group identifier refers to one or more subscriptions. The modified version can be generated e.g., by means of pre-configured mapping, automatic or algorithmic modification, etc.

At step S504, the network entity generates a token for the modified version of one or both of the external UE identification and the external group identifier. The token may be generated by means of any tokenization technology, e.g., those used for data security, or any other means that generate a non-sensitive element (token).

In some examples, a mapping between SUPI and the external identifier is stored in the entity (e.g. UDM). Formats of sensitive data and tokenized data may in some examples be aligned, and definitions of external identifier may be reused even when they are tokenized to be application function-specific.

In some examples, for a subscriber SUPI a decorated (modified) version of the SUPI is produced using the ASP identifier that may still fit within the SUPI format, and a token for that one using tokenization algorithms is then produced.

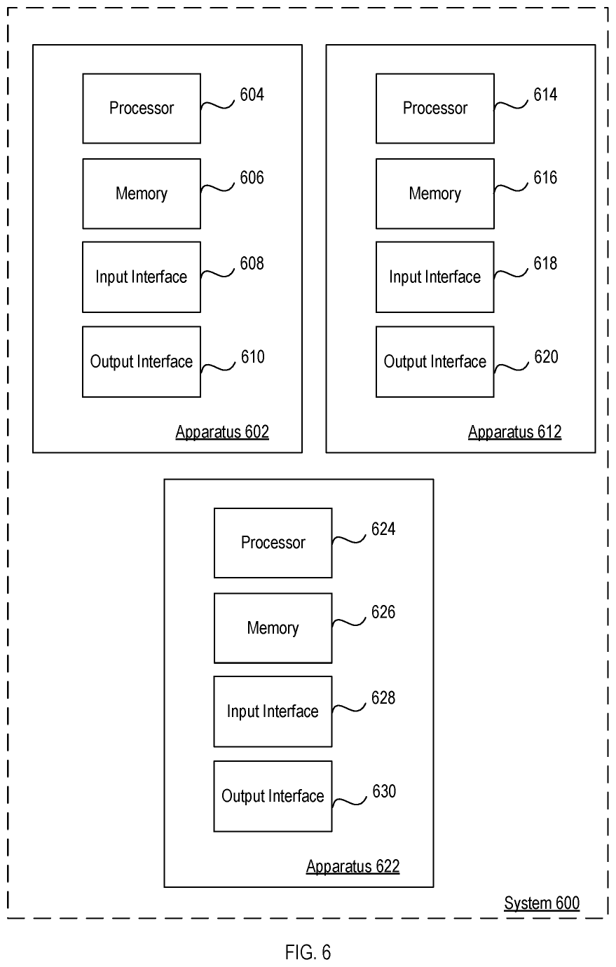

FIG. 6 is a block diagram of a system 600 according to some examples of the present disclosure.

The system comprises in this example an apparatus 602, an apparatus 612 and an apparatus 622.

The apparatus 602 comprises, in this example, a processor 604, a memory 606, an input interface 608 and an output interface 610.

The apparatus 602 is adapted to operate in a CND of a wireless communication network 100. The apparatus 602 is configured to receive, from a second entity, a request to retrieve user equipment, UE, identification. Furthermore, the apparatus 602 is configured, in response to the request, to send, to a third network entity in the CND, a request to retrieve from the third network entity the UE identification which is specific to the second entity. The apparatus 602 is further configured to receive, from the third network entity, the UE identification specific to the second entity, and send, to the second entity, the UE identification specific to the second entity.

The apparatus 612 comprises, in this example, a processor 614, a memory 616, an input interface 618 and an output interface 620.

The apparatus 612 is adapted to operate in a wireless communication network 100. The apparatus is configured to send, to a first network entity in a CND of the wireless communication network, a request to retrieve user equipment, UE, identification which is specific to the apparatus 612. The apparatus 612 is further configured to receive, from the first network entity, the UE identification specific to the apparatus.

The apparatus 622 comprises, in this example, a processor 624, a memory 626, an input interface 628 and an output interface 630.

The apparatus 622 is adapted to operate in a wireless communication network 100. The apparatus 622 is configured to generate, using an application service provider identifier, a modified version of one or both of external user equipment, UE, identification and an external group identifier. The external UE identification identifies a subscription for the UE and the external group identifier refers to one or more subscriptions. The apparatus 622 is further configured to generate a token for the modified version of one or both of the external UE identification and the external group identifier.

In the prior art, no solution has been described to provision AF with external identifiers that comply with 3GPP TSG-WG SA2 Meeting #143E e-meeting, S2-2101307. The prior art claims to address NAT scenarios but it is not specified how nor prepared for it.

The present disclosure address, inter alia, non-IP PDU Sessions (i.e. cases where AF provides a MAC address and not a UE IP address). It may also solve the scenarios where the AF needs to be provisioned an External group identifier. The present disclosure further provides a BSF based solution while taking into account that PCF/BSF are optional NFs in the network and may not be deployed. The present disclosure further does not assume that BSF is returning the GPSI and solves provision of external identifiers to be AF specific.

According to examples of the present disclosure, the NEF provides a new service for AF to be provisioned with the external subscriber and/or subscriber groups identifiers that it may need in the interaction with 3GPP Core Network in many services.

The AF may provide as input:
the type of request: whether GPSI, External-Group identifier or both are being requested
the UE IP address and port both in the client and the server side for IP type PDU Sessions and the UE MAC address for non-IP ethernet type PDU Session
ASP identifiers with different granularity levels, so that 5GC can provide External Identifiers specific to the requester. Those may include one or more of Application port ID, AF Service Identifier, and MTC Provider Information.

For 5GC network to provide the service above, the solution presented herein may
extend the UDM subscription data with subscriber GPSIs per AF Service Identifier, Application port ID and MTC Provider, and extend the UDM subscriber group data with External-group Identifiers per AF Service Identifier, Application port ID and MTC Provider;
enhance the UDM service so NEF can request to UDM the GPSI for certain SUPI that apply to the Application, AF Service or MTC, and also enhance the UDM service so NEF can request the External-group identifier(s) for the groups the subscriber identified by the SUPI belongs to;
as the alternative for network deployments with PCF and BSF (PCF/BSF are optional NFs), NEF uses existing BSF service to obtain the SUPI that corresponds to certain UE address;
as the alternative for network deployments when PCF and BSF are not deployed, SMF provides a new service that NEF uses to obtain from SMF the SUPI that corresponds to the UE address.

By defining, in some examples, as input parameters UE address and application port (client and server side) for IP type PDU sessions, scenarios with network address translation (NAT) can be supported. Solutions may, in some examples, require that the NEF obtains from NAT information of the translation performed. The NEF can then translate the UE IP address and port after NAT (provided by the AF) to UE IP address and port before NAT, and interact with BSF or SMF using the UE IP address they understand.

Examples described herein allow for extending UDM subscriber and subscriber group management to include handling of GPSI and External-group identifier(s) specific to an application, AF Service or MTC provider. Furthermore, the service operation may be extended to get subscriber data from UDM based on SUPI to support the retrieval also of External group identifiers. A new service may be defined for AF to get a valid External identifier for subscriber or subscriber group from UE address, where, as UE address: (i) AF provides UE IP address and port (client and server side), if IP Type PDU Session, which allows to support some scenarios where NAT is deployed, and/or (ii) AF provides the MAC address, if non-IP ethernet PDU Sessions take place. The NEF may be extended to receive information from NAT (e.g. become an IPFIX collector) and to translate UE IP address and port after NAT (provided by AF) to UE IP address and port before NAT (as in NAT reports). Furthermore, a new SMF service may be defined to obtain the SUPI that corresponds with a UE address (scenarios without PCF and BSF). The solution leverages existing BSF service to obtain the SUPI that corresponds with a UE address (in scenarios with PCF and BSF only).

Compared to the solutions in the prior art, examples according to the present disclosure allow to provide Application/AF-service/MTC provider specific external identifiers. By including this information as input in the new service offered to AF and involving UDM, examples outlined herein enhance to provide customized external identifiers. UDM, in charge of identify handling, may handle as many user and group external identifiers as desired (compared to solutions where BSF provides the information directly).

Further still, examples described herein support network address translated scenarios. If the AF provides the UE address and port (client and server side), the NEF can derive the addresses before NAT from the UE address and port after NAT if it receives from NAT information of network address translated service connections.

Examples according to the present disclosure further solve the provisioning of external identifiers to refer to groups of users, by storing those in UDM and providing for SUPI. This case had not been addressed before. It is solved by allowing to explicitly request external group identifiers for the UE address owner and then also in subscriber data requests to UDM for the SUPI owner.

Furthermore, examples outlined herein support also the scenario where PCF/BSF are not deployed. This has not been addressed before. It is solved by defining a new service for SMF to provide the SUPI that corresponds to a certain UE address.

To avoid correction among AFs, AF specific identifiers may be used according to examples as described herein.

It will be appreciated that the present disclosure has been described with reference to exemplary embodiments that may be varied in many aspects. As such, the present invention is only limited by the claims that follow.

1-33. (canceled)

34. A method performed by a first network entity in a core network domain (CND) of a wireless communication network, wherein the method comprises:
receiving, by the first network entity from a second entity, a request to retrieve user equipment (UE) identification;
in response to the request, sending, by the first network entity to a third network entity in the CND, a request to retrieve from the third network entity the UE identification which is specific to the second entity;
receiving, by the first network entity from the third network entity, the UE identification specific to the second entity; and
sending, by the first network entity to the second entity, the UE identification specific to the second entity;
wherein the second entity is an application function.

35. The method as claimed in claim 34, wherein the first network entity is a Network Exposure Function (NEF), the second entity is an Application Function (AF), and the third network entity is a Unified Data Management (UDM).

36. The method as claimed in claim 34, wherein the request to retrieve UE identification received by the first network entity from the second entity comprises a UE internet protocol (IP) address and an application port identification in an application client in the UE.

37. The method as claimed in claim 36, further comprising translating, by the first network entity, the UE IP address and the application port identification after a network address translation (NAT) into a UE IP address and application port identification before NAT.

38. The method as claimed in claim 34, wherein the request to retrieve UE identification received by the first network entity from the second entity comprises an indicator to request an external group identifier, referring to one or more subscriptions, for the UE.

39. The method as claimed in claim 34, wherein the request, sent by the first network entity to the third network entity, to retrieve from the third network entity the UE identification which is specific to the second entity comprises one or more of an application port identifier, machine type communication (MTC) provider information, and a service identifier relating to the second entity.

40. The method as claimed in claim 34, wherein the request, sent by the first network entity to the third network entity, to retrieve from the third network entity the UE identification which is specific to the second entity comprises a UE group indication to indicate that a UE group identification specific to the second entity is requested.

41. The method as claimed in claim 34, wherein receiving, by the first network entity from the third network entity, the UE identification specific to the second entity comprises receiving an external identifier identifying a subscription for the UE.

42. The method as claimed in claim 34, wherein receiving, by the first network entity from the third network entity, the UE identification specific to the second entity comprises receiving an external group identifier, referring to one or more subscriptions, for the UE.

43. The method as claimed in claim 34, wherein sending, by the first network entity to the third network entity, the request to retrieve from the third network entity the UE identification which is specific to the second entity is based on an identifier translation subscription data type field in the request being extended to include an optional external group identifier.

44. The method as claimed in claim 34, wherein sending, by the first network entity to the third network entity, the request to retrieve from the third network entity the UE identification which is specific to the second entity is based on machine type communication (MTC) provider information and/or a service identifier relating to the second entity being added as data sub keys for an identifier translation.

45. A method in a wireless communication network comprising a first network entity in a core network domain (CND) of the wireless communication network and a second entity, wherein the method is performed by the second entity and comprises:
sending, by the second entity to the first network entity, a request to retrieve user equipment (UE) identification which is specific to the second entity; and
receiving, by the second entity from the first network entity, the UE identification specific to the second entity;
wherein the second entity is an application function.

46. The method as claimed in claim 45, wherein the UE identification specific to the second entity is received by the first network entity from a third network entity in the CND based on a request, sent by the first network entity to the third network entity, to retrieve from the third network entity the UE identification which is specific to the second entity.

47. The method as claimed in claim 45, wherein the first network entity is a Network Exposure Function (NEF), the second entity is an Application Function (AF), and the third network entity is a Unified Data Management (UDM).

48. The method as claimed in claim 45, wherein the request to retrieve UE identification sent by the second entity to the first network entity comprises a UE internet protocol (IP) address and an application port identification in an application client in the UE.

49. The method as claimed in claim 45, wherein the request to retrieve UE identification sent by the second entity to the first network entity comprises an indicator to request an external group identifier, referring to one or more subscriptions, for the UE.

50. A method performed by a network entity in a core network domain (CND) of a wireless communication network, the method comprising:
generating, using an application service provider identifier, a modified version of one or both of external user equipment (UE) identification and an external group identifier, wherein the external UE identification identifies a subscription for the UE and wherein the external group identifier refers to one or more subscriptions; and
generating a token for the modified version of one or both of the external UE identification and the external group identifier.

51. The method as claimed in claim 50, wherein the network entity is a Unified Data Management (UDM).

52. The method as claimed in claim 50, wherein the modified version of one or both of the external UE identification and the external group identifier are specific to an entity in or coupled to the wireless communication network.

53. A first network entity configured for operation in a core network domain (CND) of a wireless communication network, wherein the first network entity comprises:
input and output interfaces configured for communicating with other network entities; and
processing circuitry configured to use the input and output interfaces to:
receive, from a second entity, a request to retrieve user equipment (UE) identification;
in response to the request, send, to a third network entity in the CND, a request to retrieve from the third network entity the UE identification which is specific to the second entity;
receive, from the third network entity, the UE identification specific to the second entity; and
send, to the second entity, the UE identification specific to the second entity, wherein the second entity is an application function.
